(19) United States
(12) Patent Application Publication
(10) Pub. No.: US 2025/0326953 A1
(43) Pub. Date: Oct. 23, 2025

(54) PRESSURE-SENSITIVE ADHESIVE COMPOSITION, PRESSURE-SENSITIVE ADHESIVE SHEET, LAMINATE, AND GLUCAN DERIVATIVE

(71) Applicant: NITTO DENKO CORPORATION, Ibaraki-shi, Osaka (JP)

(72) Inventors: Yoshiko OGINO, Osaka (JP); Katsunori ITO, Osaka (JP)

(73) Assignee: NITTO DENKO CORPORATION, Ibaraki-shi, Osaka (JP)

(21) Appl. No.: 18/867,551

(22) PCT Filed: May 23, 2023
(86) PCT No.: PCT/JP2023/019206

§ 371 Date: Nov. 20, 2024

(30) Foreign Application Priority Data
May 24, 2022 (JP) 2022-084805

(51) Int. Cl. C09J 7/38; C09J 11/08

(52) U.S. Cl. CPC C09J 7/38; C09J 11/08; C09J 2301/302; C09J 2301/408

(57) ABSTRACT

The present invention provides a novel pressure-sensitive adhesive composition including a glucan derivative. The pressure-sensitive adhesive composition of the present invention includes a glucan derivative G having a glucoside bond A, and a glucoside bond B having a different bonding form from the glucoside bond A. The glucoside bond A is, for example, a 1,6-glucoside bond. A pressure-sensitive adhesive sheet 1 of the present invention is formed from the pressure-sensitive adhesive composition. A laminate 10 of the present invention includes the pressure-sensitive adhesive sheet 1 and a substrate sheet 2.

### TECHNICAL FIELD

The present invention relates to a pressure-sensitive adhesive composition, a pressure-sensitive adhesive sheet, a laminate, and a glucan derivative.

### BACKGROUND ART

In recent years, bioplastics in which renewable resources are utilized have been examined from the viewpoint of reducing a load on the environment. As the renewable resource, for example, polysaccharides derived from organisms and plants are known. Specific examples of such polysaccharides include glucan containing glucose (specifically, D-glucose) as a constituent sugar.

Examination for introducing substituents into glucan to synthesize a glucan derivative has been made from the viewpoint of effectively utilizing glucan. For example, Patent Literature 1 discloses examination for introducing substituents into paramylon that is a kind of glucan to synthesize a paramylon derivative. Paramylon is β-1,3-glucan synthesized by photosynthesis of microalgae such as Euglena, and does not have glucoside bonds other than a β-1,3-glucoside bond.

### CITATION LIST

### Patent Literature

Patent Literature 1: JP 7012984 B

### SUMMARY OF INVENTION

### Technical Problem

A novel pressure-sensitive adhesive composition containing a glucan derivative is required from the viewpoint of reducing a load on the environment.

### Solution to Problem

The inventors of the present invention have found, as a result of thorough examinations, that, in a case where a pressure-sensitive adhesive composition is produced by using a paramylon derivative, there is room for improvement in peeling strength in a pressure-sensitive adhesive sheet formed from the pressure-sensitive adhesive composition. The inventors of the present invention have advanced examination based on the finding, and have found anew that the peeling strength of the pressure-sensitive adhesive sheet is influenced by a bonding form of a glucoside bond included in a glucan derivative, and have completed the present invention.

The present invention provides a pressure-sensitive adhesive composition including a glucan derivative having a glucoside bond A, and a glucoside bond B having a different bonding form from the glucoside bond A.

Furthermore, the present invention provides a pressure-sensitive adhesive sheet formed from the above-described pressure-sensitive adhesive composition.

Furthermore, the present invention provides a laminate including:
the above-described pressure-sensitive adhesive sheet; and
a substrate sheet.

Furthermore, the present invention provides a glucan derivative including:
a glucoside bond A;
a glucoside bond B having a different bonding form from the glucoside bond A; and
an acyl group having 8 to 16 carbon atoms.

### Advantageous Effects of Invention

The present invention can provide the novel pressure-sensitive adhesive composition including the glucan derivative.

### BRIEF DESCRIPTION OF THE DRAWINGS

FIG. 1 is a cross-sectional view schematically showing a pressure-sensitive adhesive sheet according to one embodiment of the present invention.

FIG. 2 is a drawing illustrating a method for measuring a peeling strength of the pressure-sensitive adhesive sheet.

FIG. 3 is a cross-sectional view schematically showing a laminate according to one embodiment of the present invention.

FIG. 4 is a cross-sectional view schematically showing a laminate according to a modification.

### DESCRIPTION OF EMBODIMENTS

A pressure-sensitive adhesive composition according to a first aspect of the present invention includes a glucan derivative having a glucoside bond A, and a glucoside bond B having a different bonding form from the glucoside bond A.

According to a second aspect of the present invention, for example, in the pressure-sensitive adhesive composition according to the first aspect, the glucoside bond A is a 1,6-glucoside bond.

According to a third aspect of the present invention, for example, in the pressure-sensitive adhesive composition according to the first or the second aspect, the glucoside bond B is at least one selected from the group consisting of a 1,3-glucoside bond and a 1,4-glucoside bond.

According to a fourth aspect of the present invention, for example, in the pressure-sensitive adhesive composition according to any one of the first to the third aspects, a ratio of a number of the glucoside bonds A to a total number of glucoside bonds included in the glucan derivative is 10% to 50%.

According to a fifth aspect of the present invention, for example, in the pressure-sensitive adhesive composition according to any one of the first to the fourth aspects, the glucan derivative includes an acyl group.

According to a sixth aspect of the present invention, for example, in the pressure-sensitive adhesive composition according to the fifth aspect, a number of carbon atoms in the acyl group is 8 to 16.

According to a seventh aspect of the present invention, for example, in the pressure-sensitive adhesive composition according to the fifth or the sixth aspect, the acyl group is represented by formula (1) indicated below,

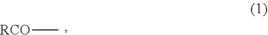

in the formula (1), R represents a hydrocarbon group.

According to an eighth aspect of the present invention, for example, in the pressure-sensitive adhesive composition according to any one of the fifth to the seventh aspects, a degree of substitution (DS value) of the acyl group in the glucan derivative is more than 2.0.

According to a ninth aspect of the present invention, for example, in the pressure-sensitive adhesive composition according to any one of the first to the eighth aspects, the glucan derivative includes at least one selected from the group consisting of a pullulan derivative and a laminaran derivative.

According to a tenth aspect of the present invention, for example, in the pressure-sensitive adhesive composition according to any one of the first to the ninth aspects, the glucan derivative has a weight-average molecular weight of 5000000 or less.

According to an eleventh aspect of the present invention, for example, the pressure-sensitive adhesive composition according to any one of the first to the tenth aspects further includes a tackifier.

According to a twelfth aspect of the present invention, for example, in the pressure-sensitive adhesive composition according to the eleventh aspect, the tackifier includes at least one selected from the group consisting of a terpene-based resin, a rosin-based resin, and a petroleum-based resin.

According to a thirteenth aspect of the present invention, for example, the pressure-sensitive adhesive composition according to any one of the first to the twelfth aspects further includes a crosslinking agent.

According to a fourteenth aspect the present invention, for example, in the pressure-sensitive adhesive composition according to the thirteenth aspect, the crosslinking agent includes an isocyanate-based crosslinking agent.

A pressure-sensitive adhesive sheet according to a fifteenth aspect of the present invention is formed from the pressure-sensitive adhesive composition according to any one of the first to the fourteenth aspects.

A laminate according to a sixteenth aspect of the present invention includes:
the pressure-sensitive adhesive sheet according to the fifteenth aspect; and
a substrate sheet.

A glucan derivative according to a seventeenth aspect of the present invention includes:
a glucoside bond A;
a glucoside bond B having a different bonding form from the glucoside bond A; and
an acyl group having 8 to 16 carbon atoms.

The present invention will be described below in detail. However, the following description is not intended to limit the present invention to a specific embodiment.

### Embodiment of Pressure-Sensitive Adhesive Composition

The pressure-sensitive adhesive composition of the present embodiment includes a glucan derivative G. The glucan derivative G functions as, for example, a base polymer in the pressure-sensitive adhesive composition. The glucan derivative G has a glucoside bond A, and a glucoside bond B having a different bonding form from the glucoside bond A. In the description herein, the “glucoside bond” represents a bond for boning glucose units to each other, and represents an α-glucoside bond and/or a β-glucoside bond. The “different bonding form” means that bonding positions for the glucose units are different between the glucoside bonds A and B.

In the glucan derivative G that has the glucoside bonds A and B having the bonding forms different from each other, a distance between molecular chains tends to be long as compared with a glucan derivative having one kind of a glucoside bond. This tends to allow the pressure-sensitive adhesive composition including the glucan derivative G to have a high pressure-sensitive adhesive strength.

In an example, the glucoside bond A may be a 1,6-glucoside bond. In this case, the glucoside bond B is a glucoside bond other than a 1,6-glucoside bond, and is, for example, at least one selected from the group consisting of a 1,2-glucoside bond, a 1,3-glucoside bond, and a 1,4-glucoside bond. The glucoside bond B is preferably at least one selected from the group consisting of a 1,3-glucoside bond and a 1,4-glucoside bond. However, the glucoside bonds A and B are not limited to the above-described combination.

A ratio P1 of the number of the glucoside bonds A, in particular, the number of 1,6-glucoside bonds to the total number of the glucoside bonds included in the glucan derivative G is, for example, 5% or more, 10% or more, 15% or more, 20% or more, and 25% or more, and furthermore, may be 30% or more. The upper limit value of the ratio P1 is not particularly limited, and is, for example, 70% and may be 50%. The ratio P1 is preferably 10% to 50%. In a case where the ratio P1 is within the above-described numerical range, the pressure-sensitive adhesive composition tends to have a sufficient pressure-sensitive adhesive strength for practical use.

A ratio P2 of the number of the glucoside bonds B, in particular, the number of glucoside bonds other than 1,6-glucoside bonds to the total number of the glucoside bonds included in the glucan derivative G is, for example, 95% or less, 90% or less, 85% or less, 80% or less, and 75% or less, and furthermore, may be 70% or less. The lower limit value of the ratio P2 is not particularly limited, and is, for example, 30% and may be 50%.

The glucan derivative G has, for example, a glucose unit U1 connected to the glucoside bond A. The glucose unit U1 may be connected to the glucoside bond B in addition to the glucoside bond A, and may not necessarily be connected to the glucoside bond B. The glucan derivative G may further have a glucose unit U2 connected to the glucoside bond B in addition to the glucose unit U1. In the description herein, the glucose units U1 and U2 may be simply referred to as glucose unit U.

In the glucan derivative G, the number of glucoside bonds (the glucoside bonds A and B) connected to one glucose unit U is 1 to 3 in general. The glucan derivative G including the glucose unit U connected to three glucoside bonds can be considered to have a branched structure. Meanwhile, the glucan derivative G merely formed of the glucose unit U connected to one glucoside bond and the glucose unit U connected to two glucoside bonds can be considered to have no branched structure and have a linear structure.

The glucose unit U has, for example, a structure in which substituents are introduced into a part or all of hydroxy groups included in an unsubstituted glucose unit. Specific examples of the substituent include an acyl group. In other words, the glucan derivative G has an acyl group as a substituent. In an example, the glucose unit U has an ester group formed by introducing an acyl group into a hydroxy group.

The number of carbon atoms in the acyl group of the glucan derivative G is, for example, 8 or more, 9 or more, 10 or more, 11 or more, or 12 or more, and furthermore, may be 13 or more. The number of carbon atoms in the acyl group is, for example, 16 or less or 15 or less, and furthermore, may be 14 or less. The number of carbon atoms in the acyl group is preferably 8 to 16. In this case, the pressure-sensitive adhesive composition tends to have a sufficient pressure-sensitive adhesive strength for practical use, and have high transparency.

According to another aspect, the present invention provides the glucan derivative G that includes
the glucoside bond A,
the glucoside bond B having a different bonding form from the glucoside bond A, and
an acyl group having 8 to 16 carbon atoms.

The glucan derivative G is particularly suitably used for a pressure-sensitive adhesive composition.

The acyl group of the glucan derivative G is, for example, represented by the following formula (1).

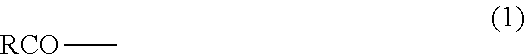

In formula (1), R represents a hydrocarbon group. The hydrocarbon group may have a substituent, but preferably has no substituents. The number of carbon atoms in the hydrocarbon group is, for example, 7 or more, 8 or more, 9 or more, 10 or more, or 11 or more, and furthermore, may be 12 or more. The number of carbon atoms in the hydrocarbon group is, for example, 15 or less or 14 or less, and furthermore, may be 13 or less. The number of carbon atoms in the hydrocarbon group is preferably 7 to 15.

Examples of the hydrocarbon group include aliphatic hydrocarbon groups, alicyclic hydrocarbon groups, and aromatic hydrocarbon groups, and aliphatic hydrocarbon groups are preferable. The aliphatic hydrocarbon group may be branched, but is preferably linear. Examples of the aliphatic hydrocarbon group include saturated aliphatic hydrocarbon groups and unsaturated aliphatic hydrocarbon groups, and saturated aliphatic hydrocarbon groups (alkyl groups) are preferable. Examples of the unsaturated aliphatic hydrocarbon group include an alkenyl group.

Examples of the alkyl group include a heptyl group, an octyl group, a nonyl group, a decyl group, an undecyl group, a dodecyl group, a tridecyl group, a tetradecyl group, and a pentadecyl group.

Specific examples of the acyl group represented by formula (1) include an octanoyl group, a nonanoyl group, a decanoyl group, a lauroyl group, a myristoyl group, and a palmitoyl group.

In the glucan derivative G, a degree of substitution (DS value) of the acyl group is, for example, more than 2.0, 2.3 or more, 2.4 or more, 2.5 or more, 2.6 or more, 2.7 or more, 2.8 or more, or 2.9 or more, and furthermore, is preferably 3.0. In a case where the DS value of the acyl group is great to such a degree, interaction between molecular chains becomes weak in the glucan derivative G, and a pressure-sensitive adhesive strength of the pressure-sensitive adhesive composition tends to be increased. In a case where the DS value of the acyl group is more than 2.0, since the number of hydroxy groups (OH groups) remaining in the glucan derivative G is small, the pressure-sensitive adhesive sheet can also be inhibited from becoming excessively hard due to influence of hydrogen bonds when the pressure-sensitive adhesive sheet is formed from the pressure-sensitive adhesive composition. However, the DS value of the acyl group may be less than 3.0, 2.9 or less, or 2.8 or less depending on the cases. In this case, when the pressure-sensitive adhesive sheet is formed from the pressure-sensitive adhesive composition, hydroxy groups remaining in the glucan derivative G can react with a crosslinking agent described below.

The DS value specifically represents the number of acyl groups in one glucose unit U included in the glucan derivative G. In a case where the DS value is 3, the glucan derivative G is considered to have a structure in which acyl groups are introduced in almost all of hydroxy groups included in an unsubstituted glucose unit. The DS value can be specified by nuclear magnetic resonance spectroscopy (1H-NMR) for the glucan derivative G. Specifically, an NMR spectrum is obtained by 1H-NMR for the glucan derivative G. From the obtained NMR spectrum, peaks derived from hydrogen atoms that are bonded directly to 1-position to 6-position carbon atoms in the glucose unit U of the glucan derivative G, and a peak derived from an acyl group are specified. The DS value can be specified based on integral values of these peaks.

The glucan derivative G can be classified into an α-glucan derivative including an α-glucoside bond and a β-glucan derivative including a β-glucoside bond. Specific examples of the α-glucan derivative include a pullulan derivative. The pullulan derivative is, for example, represented by the following formula (α1). Specific examples of the β-glucan derivative include a laminaran derivative. The laminaran derivative is, for example, represented by the following formula (β1).

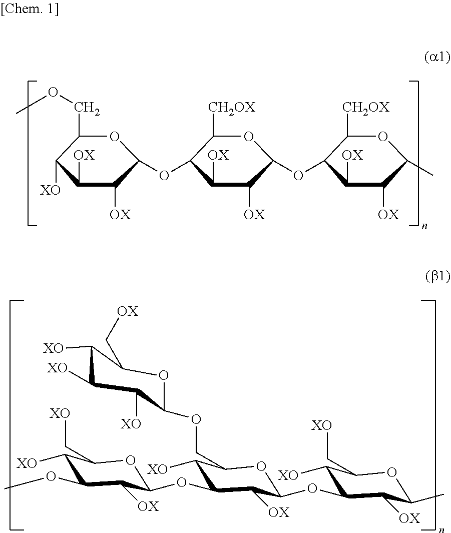

In each of formulas (α1) and (β1), n represents an integer. Xs each independently represent a hydrogen atom (however, excluding a case where all of Xs each represent a hydrogen atom) or any substituent. Xs may be the same or different from each other. Specific examples of any substituent include an acyl group. Examples of the acyl group include the above-described ones.

The glucan derivative G preferably includes at least one selected from the group consisting of a pullulan derivative and a laminaran derivative, and more preferably includes a pullulan derivative. In a case where the glucan derivative G includes a pullulan derivative, anchoring failure and cohesive failure tend to be reduced in the pressure-sensitive adhesive sheet formed from the pressure-sensitive adhesive composition. In a case where the glucan derivative G includes both a pullulan derivative and a laminaran derivative, a weight ratio between the pullulan derivative and the laminaran derivative is not particularly limited, and is, for example, 5:95 to 99:1 or 30:70 to 95:5, and furthermore, may be 50:50 to 90:10.

The weight-average molecular weight of the glucan derivative G is not particularly limited, and is, for example, 10000 or more, 30000 or more, 100000 or more, 150000 or more, 200000 or more, or 300000 or more, and furthermore, may be 400000 or more. The weight-average molecular weight of the glucan derivative G is, for example, 5000000 or less, 3000000 or less, 2500000 or less, 2000000 or less, 1000000 or less, or 800000 or less, and furthermore, may be 500000 or less. The weight-average molecular weight of the glucan derivative G is preferably 150000 to 2500000.

The glucan derivative G can be, for example, synthesized by introducing a substituent, in particular, an acyl group into an unsubstituted glucan having the glucoside bonds A and B. In an example, the glucan derivative G into which acyl groups are introduced can be synthesized through reaction between hydroxy groups included in the glucan and an acylating agent. Examples of the acylating agent include acid chlorides and acid anhydrides. A condition for the reaction between the glucan and the acylating agent, etc., can be set as appropriate according to the kinds of the glucan and the acylating agent.

The weight-average molecular weight of the glucan into which the substituents have yet to be introduced is not particularly limited, and is, for example, 10000 or more, 30000 or more, 100000 or more, 200000 or more, or 300000 or more, and furthermore, may be 400000 or more. The weight-average molecular weight of the glucan is, for example, 1000000 or less or 800000 or less, and furthermore, may be 500000 or less.

In the pressure-sensitive adhesive composition, a content of the glucan derivative G is not particularly limited, and is, for example, 1 wt % or more, 10 wt % or more, 30 wt % or more, 50 wt % or more, or 80 wt % or more, and furthermore, may be 90 wt % or more. The pressure-sensitive adhesive composition may be substantially formed merely of the glucan derivative G.

The pressure-sensitive adhesive composition may further include an additive in addition to the glucan derivative G. Examples of the additive include another base polymer, a tackifier, a crosslinking agent, a photoradical generator, a radically polymerizable compound, a solvent, a viscosity adjusting agent, a leveling agent, a plasticizer, a filler, a stabilizer, a preservative, and an anti-aging agent. The pressure-sensitive adhesive composition may further include a tackifier and may further include a crosslinking agent, as the additive. The pressure-sensitive adhesive composition may not necessarily include a crosslinking agent.

Examples of the other base polymer include a (meth)acrylic resin.

The tackifier is a component for enhancing a pressure-sensitive adhesive strength of the pressure-sensitive adhesive composition. The tackifier includes, for example, at least one selected from the group consisting of a terpene-based resin, a rosin-based resin, and a petroleum-based resin.

Examples of the terpene-based resin include terpene resins, hydrides of terpene resins, aromatic modified terpene resins, phenol-modified terpene resins, and hydrides of phenol-modified terpene resins, and a phenol-modified terpene resin is preferable. Examples of the terpene resin include α-pinene polymers, β-pinene polymers, and dipentene polymers.

Examples of the rosin-based resin include disproportionated rosin, rosin ester, phenol-modified rosin, hydrogenated rosin, polymerized rosin, maleated rosin, fumarated rosin, and disproportionated maleic acid-modified rosin resin, and rosin ester and phenol-modified rosin are preferable. Examples of the rosin ester include pentaerythritol ester-modified rosin resin.

Examples of the petroleum-based resin include aliphatic (C5) petroleum resins, aromatic (C9) petroleum resins, aliphatic/aromatic copolymerization (C5/C9) petroleum resins, hydrogenated products thereof, modified products thereof (for example, maleic anhydride modified product), coumarone resins, coumarone-indene resins, and styrene-based tackifiers, and a hydrogenated product, in particular, a hydrogenated product of an aromatic (C9) petroleum resin is preferable.

A blending amount of the tackifier is not particularly limited. In an example, a blending amount of the tackifier with respect to 100 parts by weight of the glucan derivative G is, for example, 5 parts by weight or more or 10 parts by weight or more, and furthermore, may be 20 parts by weight or more. A blending amount of the tackifier with respect to 100 parts by weight of the glucan derivative G is, for example, 150 parts by weight or less, 120 parts by weight or less, 100 parts by weight or less, 90 parts by weight or less, 70 parts by weight or less, or 60 parts by weight or less, and furthermore, may be 40 parts by weight or less.

The crosslinking agent is preferably a crosslinking agent that can react with hydroxy groups remaining in the glucan derivative G. Examples of the crosslinking agent include isocyanate-based crosslinking agents, oxazoline-based crosslinking agents, carbodiimide-based crosslinking agents, and epoxy crosslinking agents. The crosslinking agent may include a compound C containing (meth)acryloyl groups and hydroxy group-reactive functional groups. The crosslinking agent preferably includes an isocyanate-based crosslinking agent.

Examples of the isocyanate-based crosslinking agent include adduct-type isocyanate-based crosslinking agents, isocyanurate-type isocyanate-based crosslinking agents, and allophanate-type isocyanate-based crosslinking agents. Furthermore, examples of the isocyanate-based crosslinking agent include hexamethylene diisocyanate (HDI)-type crosslinking agents, tolylene diisocyanate (TDI)-type crosslinking agents, xylylene diisocyanate (XDI)-type crosslinking agents, and hydrogenated xylylene diisocyanate (H6XDI) (also known as 1,3-bis(isocyanatomethyl)cyclohexane)-type crosslinking agents.

Examples of the HDI-type crosslinking agent include a trimethylolpropane adduct of HDI, isocyanurate of HDI, and allophanate of HDI, and isocyanurate of HDI is preferable. In a case where isocyanurate of HDI is used, a component of the pressure-sensitive adhesive composition tends to be inhibited from remaining in an adherend. Examples of the TDI-type crosslinking agent include a trimethylolpropane adduct of TDI, isocyanurate of TDI, and allophanate of TDI. Examples of the XDI-type crosslinking agent include a trimethylolpropane adduct of XDI, isocyanurate of XDI, and allophanate of XDI. Examples of the H6XDI-type crosslinking agent include H6XDI, a trimethylolpropane adduct of H6XDI, isocyanurate of H6XDI, and allophanate of H6XDI.

In the compound C containing (meth)acryloyl groups and hydroxy group-reactive functional groups, the (meth)acryloyl group represents acryloyl group and/or methacryloyl group. Examples of the hydroxy group-reactive functional group include an isocyanate group, an epoxy group, an alkoxysilyl group, an acid anhydride group, and an acid chloride group, and an isocyanate group is preferable. The number of the (meth)acryloyl groups included in the compound C may be one, or two or more. The number of the hydroxy group-reactive functional groups included in the compound C may be one, or two or more.

By the hydroxy group-reactive functional group, the compound C can react with hydroxy groups remaining in the glucan derivative G. By causing the compound C to react with the glucan derivative G, the (meth)acryloyl groups can be introduced into the glucan derivative G. By causing a plurality of the glucan derivatives G to react with each other by using the (meth)acryloyl groups, the glucan derivatives G can be crosslinked. In the description herein, a reaction product of the glucan derivative G and the compound C may also be simply referred to as the glucan derivative G.

Examples of the compound C including isocyanate groups as the hydroxy group-reactive functional groups include isocyanatoalkyl (meth)acrylate and (meth)acryloyl(poly)oxyalkylene alkyl isocyanate. Specific examples of the isocyanatoalkyl (meth)acrylate include isocyanatomethyl (meth)acrylate, isocyanatoethyl (meth)acrylate, isocyanatopropyl (meth)acrylate, and isocyanatobutyl (meth)acrylate. Examples of the (meth)acryloyl(poly)oxyalkylene alkyl isocyanate include (meth)acryloylpolyoxyethylene ethyl isocyanate and (meth)acryloyloxyethyloxyethyl isocyanate.

As the compound C including isocyanate groups, a commercially available compound can be used. Examples of the commercially available compound include Karenz AOI (2-isocyanatoethyl acrylate manufactured by Showa Denko K.K.), Karenz MOI (2-isocyanatoethyl methacrylate manufactured by Showa Denko K.K.), and Karenz MOI-EG (2-(2-methacryloyloxyethyloxy)ethyl isocyanate manufactured by Showa Denko K.K.).

A blending amount of the crosslinking agent is not particularly limited. In an example, a blending amount of the crosslinking agent with respect to 100 parts by weight of the glucan derivative G is, for example, 0.01 parts by weight or more, 0.1 parts by weight or more, 0.5 parts by weight or more, 1.0 part by weight or more, or 3.0 parts by weight or more, and furthermore, may be 5.0 parts by weight or more. A blending amount of the crosslinking agent with respect to 100 parts by weight of the glucan derivative G is, for example, 50 parts by weight or less, 25 parts by weight or less, 20 parts by weight or less, or 15 parts by weight or less, and furthermore, may be 10 parts by weight or less. A blending amount of the crosslinking agent with respect to 100 parts by weight of the glucan derivative G may be 5.0 parts by weight or less or 3.0 parts by weight or less depending on the cases.

In a case where the pressure-sensitive adhesive composition includes the above-described compound C as the crosslinking agent, it is preferable that the pressure-sensitive adhesive composition further includes a photoradical generator, and the pressure-sensitive adhesive composition may further include a radically polymerizable compound. The photoradical generator is a compound that generates radicals through application of light. In the description herein, examples of the light include radiation (gamma rays, X-rays, etc.), ultraviolet rays, and visible light.

Examples of the photoradical generator include a benzyl ketal-based compound, an α-hydroxy ketone-based photopolymerization initiator, an α-amino ketone-based photopolymerization initiator, an acyl phosphine oxide-based photopolymerization initiator, an oxime ester-based photopolymerization initiator, an acridine-based photopolymerization initiator, a titanocene-based photopolymerization initiator, a benzophenone-based photopolymerization initiator, an acetophenone-based photopolymerization initiator, an aromatic ketoester-based photopolymerization initiator, and a benzoic acid ester-based photopolymerization initiator. A benzyl ketal-based compound is preferable. As the photoradical generator, a commercially available photoradical generator can be used. Examples of the commercially available photoradical generator include Omnirad 184, 369, 500, 651, 819, 907, 784, and 2959 (all of which are manufactured by IGM Resins B.V.), and CGI-1700,-1750,-1850, CG 24-61, and Darocur 1116, 1173 (all of which are manufactured by BASF).

A blending amount of the photoradical generator is not particularly limited. In an example, a blending amount of the photoradical generator with respect to 100 parts by weight of the glucan derivative G is, for example, 0.01 parts by weight or more, 0.05 parts by weight or more, or 0.075 parts by weight or more, and furthermore, may be 0.1 parts by weight or more. A blending amount of the photoradical generator with respect to 100 parts by weight of the glucan derivative G is, for example, 5 parts by weight or less, 1 part by weight or less, or 0.5 parts by weight or less, and furthermore, may be 0.2 parts by weight or less.

The radically polymerizable compound is, for example, a radically polymerizable unsaturated compound having a double bond, and examples thereof include (meth)acryls, (meth)acrylamides, aromatic vinyls, vinyl esters, and acrylonitriles. The (meth)acryl represents acryl and/or methacryl.

Examples of (meth)acryl include (meth)acrylic monomers and (meth)acrylic oligomers. In the (meth)acrylic monomer, a residue bonded to a (meth)acryloyl group includes no repeating units. The (meth)acrylic monomer may include a functional group or include no functional group. Examples of the (meth)acrylic monomer include (meth)acrylic acid alkyl ester, carboxyl group-containing (meth)acrylic monomers, and hydroxy group-containing (meth)acrylic monomers.

Examples of the (meth)acrylic acid alkyl ester include (meth)acrylic acid alkyl ester having a linear or branched aliphatic alkyl group or an alicyclic alkyl group. Specific examples of the (meth)acrylic acid alkyl ester include methyl (meth)acrylate, ethyl (meth)acrylate, butyl (meth)acrylate, 2-ethylhexyl (meth)acrylate, nonyl (meth)acrylate, lauryl (meth)acrylate, cyclohexyl (meth)acrylate, and isobornyl (meth)acrylate.

Examples of the carboxyl group-containing (meth)acrylic monomer include (meth)acrylic acid. Examples of the hydroxy group-containing (meth)acrylic monomer include 2-hydroxyethyl (meth)acrylate, 3-hydroxypropyl (meth)acrylate, and 4-hydroxybutyl (meth)acrylate.

In the (meth)acrylic oligomer, a residue bonded to a (meth)acryloyl group includes repeating units. The (meth)acrylic oligomer may include a functional group or include no functional group. Examples of the (meth)acrylic oligomer include alkoxy polyoxyalkylene glycol mono(meth)acrylate, carboxyl group-containing (meth)acrylic oligomers, and hydroxy group-containing (meth)acrylic oligomers.

Examples of alkoxy polyoxyalkylene glycol mono(meth)acrylate include alkoxy polyoxyethylene glycol mono(meth)acrylate, in particular, methoxypolyoxyethylene glycol mono (meth)acrylate.

Examples of the carboxyl group-containing (meth)acrylic oligomer include w-carboxy-polycaprolactone mono (meth)acrylate. Examples of the hydroxy group-containing (meth)acrylic oligomer include polyoxyalkylene glycol mono(meth)acrylate.

As the (meth)acrylic oligomer, a commercially available (meth)acrylic oligomer can be used. Examples of the commercially available (meth)acrylic oligomer include BLEMMER AME400 (methoxypolyethylene glycol-acrylate manufactured by NOF

CORPORATION) and ARONIX M-5300 (ω-carboxy-polycaprolactone (n (degree of polymerization)≈2) monoacrylate manufactured by TOAGOSEI CO., LTD.).

A blending amount of the radically polymerizable compound is not particularly limited. In an example, a blending amount of the radically polymerizable compound with respect to 100 parts by weight of the glucan derivative G is, for example, 0.001 parts by weight or more, 0.01 parts by weight or more, 0.1 parts by weight or more, or 1 part by weight or more, and furthermore, may be 3 parts by weight or more. A blending amount of the radically polymerizable compound with respect to 100 parts by weight of the glucan derivative G is, for example, 100 parts by weight or less or 10 parts by weight or less, and furthermore, may be 7 parts by weight or less.

The solvent may be typically an organic solvent or water. The organic solvent may be a low polarity solvent or a high polarity solvent. Examples of the low polarity organic solvent include aromatic compounds, alicyclic compounds, and saturated linear hydrocarbon compounds. Examples of the aromatic compound include toluene. Examples of the alicyclic compound include cyclohexane and methylcyclohexane. Examples of the saturated linear hydrocarbon compound include pentane, hexane, and heptane.

Examples of the high polarity organic solvent include ketone, ester, and alcohol. Examples of the ketone include methyl ethyl ketone. Examples of the ester include ethyl acetate. Examples of the alcohol include methanol and ethanol.

In a case where the pressure-sensitive adhesive composition includes the solvent, a solid content concentration of the pressure-sensitive adhesive composition is, for example, 1 wt % or more and may be 10 wt % or more. The solid content concentration of the pressure-sensitive adhesive composition may be 50 wt % or less or 40 wt % or less.

### Embodiment of Pressure-Sensitive Adhesive Sheet

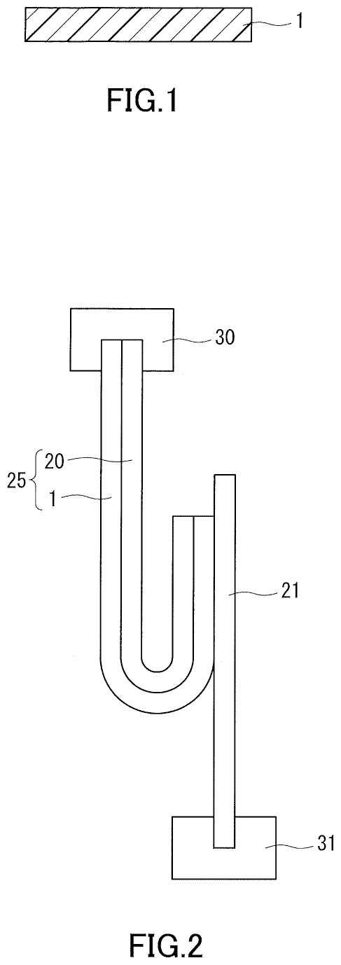

FIG. 1 shows an example of a pressure-sensitive adhesive sheet 1 according to the present embodiment. The pressure-sensitive adhesive sheet 1 is formed from the above-described pressure-sensitive adhesive composition. The thickness of the pressure-sensitive adhesive sheet 1 is not particularly limited, and is, for example, 1 μm to 1000 μm.

The pressure-sensitive adhesive sheet 1 can be, for example, produced by the following method. Firstly, the pressure-sensitive adhesive composition is applied to a substrate sheet to obtain a coating film. As the substrate sheet, a substrate sheet described below for a laminate can be used. Subsequently, the coating film is dried, and the pressure-sensitive adhesive sheet 1 can thus be obtained. The coating film can be, for example, dried by heating the coating film. The temperature for heating the coating film is not particularly limited, and is, for example, 30° C. or higher and may be 100° C. or higher. A time for heating the coating film is not particularly limited, and is, for example, 5 minutes or more and may be 30 minutes or more. In a case where the pressure-sensitive adhesive composition includes the photoradical generator, light may be applied to the coating film when or after the coating film is dried.

According to examinations made by the inventors of the present invention, the pressure-sensitive adhesive composition that includes the glucan derivative G having the glucoside bonds A and B having bonding forms different from each other can allow a peeling strength of the pressure-sensitive adhesive sheet 1 to be easily increased. In an example, a peeling strength F of the pressure-sensitive adhesive sheet 1 as measured in the test described below is, for example, 0.2 N/20 mm or more, 0.3 N/20 mm or more, 0.5 N/20 mm or more, 0.8 N/20 mm or more, 1 N/20 mm or more, 2 N/20 mm or more, 3 N/20 mm or more, 4 N/20 mm or more, 5 N/20 mm or more, or 6 N/20 mm or more, and furthermore, may be 7 N/20 mm or more. The upper limit value of the peeling strength F of the pressure-sensitive adhesive sheet 1 is not particularly limited, and is, for example, 20 N/20 mm.

The peeling strength F of the pressure-sensitive adhesive sheet 1 can be measured by the following method (FIG. 2). Firstly, a laminate formed of the pressure-sensitive adhesive sheet 1 and a substrate sheet 20 is produced. As the substrate sheet 20, for example, Lumirror S-10 (polyester film, thickness of 25 μm) manufactured by Toray Industries, Inc. is used. In the laminate, the thickness of the pressure-sensitive adhesive sheet 1 is adjusted to be, for example, 50 μm. Subsequently, the laminate is cut so as to have a width of 20 mm and a length of 70 mm, whereby a test piece 25 is produced.

Subsequently, the test piece 25 and a stainless steel test plate 21 are stacked through the pressure-sensitive adhesive sheet 1 in an environment of 23° C. and 50% RH, and a 2 kg roller is caused to reciprocate once, and the test piece 25 and the stainless steel test plate 21 are press-bonded. As the stainless steel test plate 21, for example, an SUS304BA plate is used. In this state, the obtained product is left as it is for 30 minutes, and is thereafter set at a tensile tester as shown in FIG. 2. Specifically, one end of the stainless steel test plate 21 is fixed to a lower chuck 31 of the tensile tester, and an end portion of the test piece 25 on the lower chuck 31 side is folded back by 180°, and fixed to an upper chuck 30 of the tensile tester. Subsequently, the test piece 25 is peeled off from the stainless steel test plate 21 at a peeling speed of 300 mm/min and a peeling angle of 180°. The average value of the peeling strengths obtained at this time is specified as the peeling strength F of the pressure-sensitive adhesive sheet 1.

### Embodiment of Laminate

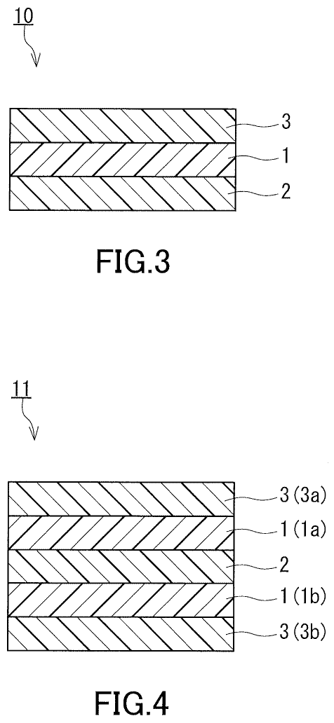

FIG. 3 shows an example of a laminate according to the present embodiment. A laminate 10 shown in FIG. 3 includes the pressure-sensitive adhesive sheet 1 and a substrate sheet 2, and may further include a release liner 3. In the laminate 10, the pressure-sensitive adhesive sheet 1 is, for example, disposed between the substrate sheet 2 and the release liner 3, and is in direct contact with each of the substrate sheet 2 and the release liner 3. The laminate 10 is typically a pressure-sensitive adhesive tape. The laminate 10 can be used by peeling the release liner 3.

The substrate sheet 2 is, for example, a sheet including resin such as polyester. The substrate sheet 2 may be subjected to release treatment at the surface in contact with the pressure-sensitive adhesive sheet 1, and may function as a release liner. The thickness of the substrate sheet 2 is not particularly limited, and is, for example, 0.5 μm to 900 μm.

The release liner 3 is, for example, a sheet that is subjected to release treatment at the surface in contact with the pressure-sensitive adhesive sheet 1. Examples of a material of the release liner 3 include resin such as polyester. The thickness of the release liner 3 is not particularly limited, and is, for example, 0.5 μm to 900 μm.

FIG. 4 shows a laminate according to a modification of the present embodiment. A laminate 11 shown in FIG. 4 includes two pressure-sensitive adhesive sheets 1 and two release liners 3. Except for this, the laminate 11 has the same structure as the laminate 10 shown in FIG. 3.

Specifically, the laminate 11 has a laminate structure in which a release liner 3a, a pressure-sensitive adhesive sheet 1a, the substrate sheet 2, a pressure-sensitive adhesive sheet 1b, and a release liner 3b are laminated in this order. The laminate 11 is typically a double-sided pressure-sensitive adhesive tape. The laminate 11 can be used by peeling the release liners 3a and 3b.

The above-described laminates 10 and 11 can be, for example, distributed and stored as a wound body obtained by winding a band-shaped laminate, or a sheet-shaped laminate.

### EXAMPLES

The present invention will be described below in more detail by way of examples and comparative examples. However, the present invention is not limited to these examples.

### Pullulan Derivative 1

Firstly, 10 g of pullulan (pullulan manufactured by Hayashibara Co., Ltd.) and 1000 mL of dehydrated pyridine (manufactured by FUJIFILM Wako Pure Chemical Corporation) were added into a reaction vessel having a condenser tube, a nitrogen introducing tube, a thermometer, and a stirrer. The pullulan had an α-1,6-glucoside bond as the glucoside bond A and an α-1,4-glucoside bond as the glucoside bond B. The ratio P1 of the number of the glucoside bonds A to the total number of the glucoside bonds included in the pullulan was 33%. The weight-average molecular weight of the pullulan was 500000.

Subsequently, the obtained mixed solution was heated to 90° C. and stirred in a nitrogen atmosphere for 0.5 hours. Subsequently, 100 ml of myristoyl chloride (manufactured by FUJIFILM Wako Pure Chemical Corporation) was added to the mixed solution, and the resultant product was stirred at 90° C. for 1.5 hours. Thus, a reaction between the pullulan and the myristoyl chloride progressed.

Subsequently, 2000 mL of methanol was added to the reaction solution, and the resultant product was cooled to room temperature. Subsequently, a solid in the reaction solution was taken out and dissolved in 600 mL of toluene, to obtain a toluene solution. Subsequently, the obtained toluene solution was poured into 2000 mL of methanol being stirred, to precipitate a solid. This re-precipitation process was repeated three times. Subsequently, a solid obtained by the re-precipitation process was dried under a reduced pressure at 60° C. for 4 hours, to obtain a pullulan derivative 1. The pullulan derivative 1 had a structure in which myristoyl groups (C14 acyl groups) were introduced into the pullulan. In the pullulan derivative 1, the degree of substitution (DS value) of the acyl group was 2.6.

### Pullulan Derivative 2

A pullulan derivative 2 was synthesized in the same method as for the pullulan derivative 1 except that 90 mL of lauroyl chloride was used instead of myristoyl chloride. The pullulan derivative 2 had a structure in which lauroyl groups (C12 acyl groups) were introduced into the pullulan. In the pullulan derivative 2, the DS value of the acyl group was 2.6.

### Pullulan Derivative 3

A pullulan derivative 3 was synthesized in the same method as for the pullulan derivative 2 except that an amount of lauroyl chloride to be used was changed such that the DS value of the lauroyl group (C12 acyl group) was 2.4.

### Pullulan Derivative 4

A pullulan derivative 4 was synthesized in the same method as for the pullulan derivative 1 except that 65 mL of capryloyl chloride was used instead of myristoyl chloride. The pullulan derivative 4 had a structure in which capryloyl groups (C8 acyl groups) were introduced into the pullulan. In the pullulan derivative 4, the DS value of the acyl group was 3.0.

### Pullulan Derivative 5

A pullulan derivative 5 was synthesized in the same method as for the pullulan derivative 1 except that 115 mL of palmitoyl chloride was used instead of myristoyl chloride. The pullulan derivative 5 had a structure in which palmitoyl groups (C16 acyl groups) were introduced into the pullulan. In the pullulan derivative 5, the DS value of the acyl group was 3.0.

### Laminaran Derivative 1

Firstly, 10 g of laminaran (laminarin manufactured by NACALAI TESQUE, INC.) and 1000 mL of dehydrated pyridine (manufactured by FUJIFILM Wako Pure Chemical Corporation) were added into a reaction vessel having a condenser tube, a nitrogen introducing tube, a thermometer, and a stirrer. The laminaran had a β-1,6-glucoside bond as the glucoside bond A and a β-1,3-glucoside bond as the glucoside bond B. The ratio P1 of the number of the glucoside bonds A to the total number of the glucoside bonds included in the laminaran was 25%. The weight-average molecular weight of the laminaran was 30000 to 40000.

Subsequently, the obtained mixed solution was heated to 90° C. and stirred in a nitrogen atmosphere for 0.5 hours. Subsequently, 90 mL of lauroyl chloride was added to the mixed solution, and the resultant product was stirred at 90° C. for 1.5 hours. Thus, a reaction between the laminaran and the lauroyl chloride progressed.

Subsequently, 2000 mL of methanol was added to the reaction solution, and the resultant product was cooled to room temperature. Subsequently, a solid in the reaction solution was taken out and dissolved in 600 mL of toluene, to obtain a toluene solution. Subsequently, the obtained toluene solution was poured into 2000 mL of methanol being stirred, to precipitate a solid. This re-precipitation process was repeated three times. Subsequently, a solid obtained by the re-precipitation process was dried under a reduced pressure at 60° C. for 4 hours, to obtain a laminaran derivative 1. The laminaran derivative 1 had a structure in which lauroyl groups (C12 acyl groups) were introduced into the laminaran. In the laminaran derivative 1, the DS value of the acyl group was 3.0.

### Laminaran Derivative 2

A laminaran derivative 2 was synthesized in the same method as for the laminaran derivative 1 except that 100 mL of myristoyl chloride was used instead of lauroyl chloride. The laminaran derivative 2 had a structure in which myristoyl groups (C14 acyl groups) were introduced into the laminaran. In the laminaran derivative 2, the DS value of the acyl group was 3.0.

### Example 1

Firstly, the pullulan derivative 1 was dissolved in toluene, to prepare a pressure-sensitive adhesive composition having a solid content concentration of 20 wt %. The pressure-sensitive adhesive composition was applied to a substrate sheet to produce a coating film. As the substrate sheet, Lumirror S-10 (polyester film, thickness of 25 μm) manufactured by Toray Industries, Inc. was used. The pressure-sensitive adhesive composition was applied by using an applicator (manufactured by TESTER SANGYO CO,. LTD.). Subsequently, the coating film was dried at 60° C. for 5 minutes, to obtain a pressure-sensitive adhesive sheet of Example 1. The pressure-sensitive adhesive sheet had a thickness of 50 μm.

### Examples 2 to 4

Pressure-sensitive adhesive sheets of Examples 2 to 4 were each obtained in the same method as in Example 1 except that the kind of the glucan derivative was changed as indicated in Table 1.

### Example 5

Firstly, the pullulan derivative 1 was dissolved in toluene, to prepare a toluene solution S1 having a solid content concentration of 20 wt %. Subsequently, a phenol-modified terpene resin (YS POLYSTER T-130 manufactured by YASUHARA CHEMICAL CO., LTD.) as a tackifier was dissolved in toluene, to prepare a toluene solution S2 having a solid content concentration of 20 wt %. The toluene solutions S1 and S2 were mixed and stirred to prepare a pressure-sensitive adhesive composition. The toluene solutions S1 and S2 were mixed such that a blending amount of an aromatic modified terpene resin was 30 parts by weight with respect to 100 parts by weight of the pullulan derivative 1.

Subsequently, the obtained pressure-sensitive adhesive composition was applied to a substrate sheet to produce a coating film. As the substrate sheet, Lumirror S-10 (polyester film, thickness of 25 μm) manufactured by Toray Industries, Inc. was used. The pressure-sensitive adhesive composition was applied by using an applicator (manufactured by TESTER SANGYO CO,. LTD.). Subsequently, the coating film was dried at 60° C. for 5 minutes, to obtain a pressure-sensitive adhesive sheet of Example 5. The pressure-sensitive adhesive sheet had a thickness of 50 μm.

### Examples 6 to 8

Pressure-sensitive adhesive sheets of Examples 6 to 8 were each obtained in the same method as in Example 5 except that the kind of the glucan derivative was changed as indicated in Table 1.

### Example 9

Firstly, the pullulan derivative 1 was dissolved in toluene, to prepare a toluene solution having a solid content concentration of 20 wt %. Subsequently, an isocyanate-based crosslinking agent (TAKENATE D-101A (trimethylolpropane adduct of tolylene diisocyanate) manufactured by Mitsui Chemicals, Inc.) was blended with the toluene solution, to prepare a pressure-sensitive adhesive composition. A blending amount of the isocyanate-based crosslinking agent with respect to 100 parts by weight of the pullulan derivative 1 was 3.0 parts by weight.

Subsequently, the obtained pressure-sensitive adhesive composition was applied to a substrate sheet, to produce a coating film. As the substrate sheet, Lumirror S-10 (polyester film, thickness of 25 μm) manufactured by Toray Industries, Inc. was used. The pressure-sensitive adhesive composition was applied by using an applicator (manufactured by TESTER SANGYO CO,. LTD.). Subsequently, the coating film was treated at 60° C. for 5 minutes, at 120° C. for 3 minutes, and at 50° C. for 3 days, to obtain a pressure-sensitive adhesive sheet of Example 9. The pressure-sensitive adhesive sheet had a thickness of 50 μm.

### Examples 10 to 11

Pressure-sensitive adhesive sheets of Examples 10 to 11 were each obtained in the same method as in Example 9 except that the kind of the glucan derivative was changed as indicated in Table 2.

### Example 12

A pressure-sensitive adhesive sheet of Example 12 was obtained in the same method as in Example 5 except that the pullulan derivative 4 was used as the glucan derivative, a phenol-modified terpene resin (YS POLYSTER T-80 manufactured by YASUHARA CHEMICAL CO., LTD.) was used as the tackifier, and a blending amount of the tackifier with respect to 100 parts by weight of the glucan derivative was changed as indicated in Table 2.

### Example 13

A pressure-sensitive adhesive sheet of Example 13 was obtained in the same method as in Example 5 except that the pullulan derivative 5 was used as the glucan derivative, and a blending amount of the tackifier with respect to 100 parts by weight of the glucan derivative was changed as indicated in Table 2.

### Examples 14 to 17

Pressure-sensitive adhesive sheets of Examples 14 to 17 were each obtained in the same method as in Example 5 except that the pullulan derivative 3 was used as the glucan derivative, a rosin-based resin (PINECRYSTAL KE100 manufactured by ARAKAWA CHEMICAL INDUSTRIES, LTD.) was used as the tackifier, and a blending amount of the tackifier with respect to 100 parts by weight of the glucan derivative was changed as indicated in Table 2.

### Examples 18 to 21

Pressure-sensitive adhesive sheets of Examples 18 to 21 were each obtained in the same method as in Example 5 except that a mixture obtained by mixing the pullulan derivative 3 and the laminaran derivative 1 at a weight ratio indicated in Table 3 was used as the glucan derivative, a rosin-based resin (PINECRYSTAL KE100 manufactured by ARAKAWA CHEMICAL INDUSTRIES, LTD.) was used as the tackifier, and a blending amount of the tackifier with respect to 100 parts by weight of the glucan derivative was changed as indicated in Table 3.

### Example 22

A pressure-sensitive adhesive sheet of Example 22 was obtained in the same method as in Example 1 except that a mixture obtained by mixing the pullulan derivative 3 and the laminaran derivative 1 at a weight ratio indicated in Table 4 was used as the glucan derivative.

### Comparative Example 1

Firstly, pullulan (pullulan manufactured by Hayashibara Co., Ltd.) was dissolved in water, to prepare a pressure-sensitive adhesive composition having a solid content concentration of 20 wt %. The pressure-sensitive adhesive composition was applied to a substrate sheet, to produce a coating film. As the substrate sheet, Lumirror S-10 (polyester film, thickness of 25 μm) manufactured by Toray Industries, Inc. was used. The pressure-sensitive adhesive composition was applied by using an applicator (manufactured by TESTER SANGYO CO,. LTD.). Subsequently, the coating film was dried at 90° C. for 15 minutes, to obtain a pressure-sensitive adhesive sheet of Comparative example 1. The pressure-sensitive adhesive sheet had a thickness of 50 μm.

### Comparative Example 2

A pressure-sensitive adhesive sheet of Comparative example 2 was obtained in the same method as in Comparative example 1 except that laminaran (laminarin manufactured by NACALAI TESQUE, INC.) was used instead of pullulan.

### [Peeling Strength F]

For the pressure-sensitive adhesive sheets of the examples and the comparative examples, the peeling strength F was measured by the above-described method. The peeling strength F was measured by using, as a tensile tester, a precision universal testing machine, AUTOGRAPH AG-IS, manufactured by SHIMADZU CORPORATION. In Examples 3 and 4, while the peeling strength F was measured, peeling (anchoring failure) between the pressure-sensitive adhesive sheet and the substrate sheet was observed. In Examples 7, 8, 18, and 19, while the peeling strength F was measured, cohesive failure of the pressure-sensitive adhesive sheet was observed. In Example 11, while the peeling strength F was measured, peeling (anchoring failure) between the pressure-sensitive adhesive sheet and the substrate sheet and cohesive failure of the pressure-sensitive adhesive sheet were observed.

TABLE 1

| | | | Example | Example | Example | Example |
|---|---|---|---|---|---|---|
| | | | 1 | 2 | 3 | 4 |
| Pressure- | Glucan | Kind | pullulan | pullulan | laminaran | laminaran |
| sensitive | | | derivative 1 | derivative 2 | derivative 1 | derivative 2 |

| | | | | | |
|---|---|---|---|---|---|
| adhesive | Weight-average | 500000 | 500000 | 30000 to 40000 | 30000 to 40000 |
| composition | molecular weight | | | | |
| | (*1) | | | | |
| | Constituent | α-glucose | α-glucose | β-glucose | β-glucose |
| | monomer | | | | |
| | Glucoside bond A | α-1,6- | α-1,6- | β-1,6- | β-1,6- |

| | glucoside | glucoside | glucoside | glucoside |
|---|---|---|---|---|
| Glucoside bond B | α-1,4- | α-1,4- | β-1,3- | β-1,3- |
| | glucoside | glucoside | glucoside | glucoside |
| Ratio P1 [%] (*2) | 33 | 33 | 25 | 25 |
| The number of | 14 | 12 | 12 | 14 |
| carbon atoms in | | | | |
| acyl group | | | | |
| Degree of | 2.6 | 2.6 | 3.0 | 3.0 |
| substitution (DS | | | | |
| value) | | | | |

| Tackifier | Kind | — | — | — | — |
|---|---|---|---|---|---|
| | Blending | — | — | — | — |
| | amount | | | | |
| | (parts by | | | | |
| | weight) | | | | |
| Crosslinking | Kind | — | — | — | — |
| agent | Blending | — | — | — | — |

amount
(parts by
weight)

| | | | | | |
|---|---|---|---|---|---|
| Characteristics | Peeling strength F | 7.87 | 8.82 | >2.07 (*3) | >1.5 (*3) |
| | [N/20 mm] | | | | |

| | | | Example 5 | Example 6 | Example 7 | Example 8 |
|---|---|---|---|---|---|---|
| Pressure- | Glucan | Kind | pullulan | pullulan | laminaran | laminaran |
| sensitive | | | derivative 1 | derivative 2 | derivative 2 | derivative 1 |

| | | | | | |
|---|---|---|---|---|---|
| adhesive | Weight-average | 500000 | 500000 | 30000 to 40000 | 30000 to 40000 |
| composition | molecular weight (*1) | | | | |
| | Constituent monomer | α-glucose | α-glucose | β-glucose | β-glucose |
| | Glucoside bond A | α-1,6- | α-1,6- | β-1,6- | β-1,6- |

| | glucoside | glucoside | glucoside | glucoside |
|---|---|---|---|---|
| Glucoside bond B | α-1,4- | α-1,4- | β-1,3- | β-1,3- |
| | glucoside | glucoside | glucoside | glucoside |
| Ratio P1 [%] (*2) | 33 | 33 | 25 | 25 |
| The number of | 14 | 12 | 14 | 12 |
| carbon atoms in acyl | | | | |
| group | | | | |
| Degree of | 2.6 | 2.6 | 3.0 | 3.0 |
| substitution (DS | | | | |
| value) | | | | |

| Tackifier | Kind | terpene- | terpene- | terpene- | terpene- |
|---|---|---|---|---|---|
| | | based | based | based | based |
| | | resin T-130 | resin T-130 | resin T-130 | resin T-130 |
| | Blending | 30 | 30 | 30 | 30 |
| | amount | | | | |
| | (parts by | | | | |
| | weight) | | | | |
| Crosslinking agent | Kind | — | — | — | — |

| | | | | |
|---|---|---|---|---|
| Blending | — | — | — | — |
| amount | | | | |
| (parts by | | | | |
| weight) | | | | |

| | | | | | |
|---|---|---|---|---|---|
| Characteristics | Peeling strength F [N/20 mm] | 9.91 | 10.43 | >4.19 (*4) | >4.95 (*4) |

(*1) Weight-average molecular weight of glucan prior to introduction of acyl groups
(*2) Ratio of the number of the glucoside bonds A to the total number of the glucoside bonds
(*3) Peeling (anchoring failure) between the pressure-sensitive adhesive sheet and the substrate sheet was observed while the peeling strength F was measured.
(*4) Cohesive failure of the pressure-sensitive adhesive sheet was observed while the peeling strength F was measured.

TABLE 2

| | | | Example 9 | Example 10 | Example 11 |
|---|---|---|---|---|---|
| Pressure- | Glucan | Kind | pullulan | pullulan | laminaran |
| sensitive | | | derivative 1 | derivative 2 | derivative 2 |
| adhesive | | Weight-average | 500000 | 500000 | 30000 to 40000 |
| composition | | molecular weight (*1) | | | |
| | | Constituent monomer | α-glucose | α-glucose | β-glucose |
| | | Glucoside bond A | α-1,6- | α-1,6- | β-1,6- |
| | | | glucoside | glucoside | glucoside |
| | | Glucoside bond B | α-1,4- | α-1,4- | β-1,3- |
| | | | glucoside | glucoside | glucoside |
| | | Ratio P1 [%] (*2) | 33 | 33 | 25 |
| | | The number of | 14 | 12 | 14 |
| | | carbon atoms in acyl | | | |
| | | group | | | |
| | | Degree of | 2.6 | 2.6 | 3.0 |
| | | substitution (DS | | | |
| | | value) | | | |
| | Tackifier | Kind | — | — | — |
| | | Blending amount | — | — | — |
| | | (parts by weight) | | | |
| | Crosslinking | Kind | isocyanate- | isocyanate- | isocyanate- |
| | agent | | based | based | based |
| | | | crosslinking | crosslinking | crosslinking |
| | | | agent | agent | agent |
| | | Blending amount | 3.0 | 3.0 | 3.0 |
| | | (parts by weight) | | | |

| | | | | |
|---|---|---|---|---|
| Characteristics | Peeling strength F [N/20 mm] | 1.08 | 3.92 | 1.60 (*3) |

| | | | Example 12 | Example 13 | Example 14 |
|---|---|---|---|---|---|
| Pressure- | Glucan | Kind | pullulan | pullulan | pullulan |
| sensitive | | | derivative 4 | derivative 5 | derivative 3 |
| adhesive | | Weight-average | 500000 | 500000 | 500000 |
| composition | | molecular weight (*1) | | | |
| | | Constituent monomer | α-glucose | α-glucose | α-glucose |
| | | Glucoside bond A | α-1,6- | α-1,6- | α-1,6- |
| | | | glucoside | glucoside | glucoside |
| | | Glucoside bond B | α-1,4- | α-1,4- | α-1,4- |
| | | | glucoside | glucoside | glucoside |
| | | Ratio P1 [%] (*2) | 33 | 33 | 33 |
| | | The number of | 8 | 16 | 12 |
| | | carbon atoms in acyl | | | |
| | | group | | | |
| | | Degree of | 3.0 | 3.0 | 2.4 |
| | | substitution (DS | | | |
| | | value) | | | |
| | Tackifier | Kind | terpene-based | terpene-based | rosin-based |
| | | | resin T-80 | resin T-130 | resin KE100 |
| | | Blending amount | 50 | 10 | 5 |
| | | (parts by weight) | | | |
| | Crosslinking | Kind | — | — | — |
| | agent | Blending amount | — | — | — |
| | | (parts by weight) | | | |

| | | | | |
|---|---|---|---|---|
| Characteristics | Peeling strength F [N/20 mm] | 0.24 | 0.26 | 0.53 |

| | | | Example 15 | Example 16 | Example 17 |
|---|---|---|---|---|---|
| Pressure- | Glucan | Kind | pullulan | pullulan | pullulan |
| sensitive | | | derivative 3 | derivative 3 | derivative 3 |
| adhesive | | Weight-average | 500000 | 500000 | 500000 |
| composition | | molecular weight (*1) | | | |
| | | Constituent monomer | α-glucose | α-glucose | α-glucose |
| | | Glucoside bond A | α-1,6- | α-1,6- | α-1,6- |
| | | | glucoside | glucoside | glucoside |
| | | Glucoside bond B | α-1,4- | α-1,4- | α-1,4- |
| | | | glucoside | glucoside | glucoside |
| | | Ratio P1 [%] (*2) | 33 | 33 | 33 |
| | | The number of | 12 | 12 | 12 |
| | | carbon atoms in acyl | | | |
| | | group | | | |
| | | Degree of | 2.4 | 2.4 | 2.4 |
| | | substitution (DS | | | |
| | | value) | | | |
| | Tackifier | Kind | rosin-based | rosin-based | rosin-based |
| | | | resin KE100 | resin KE100 | resin KE100 |
| | | Blending amount | 10 | 30 | 50 |
| | | (parts by weight) | | | |
| | Crosslinking | Kind | — | — | — |
| | agent | Blending amount | — | — | — |
| | | (parts by weight) | | | |

| | | | | |
|---|---|---|---|---|
| Characteristics | Peeling strength F [N/20 mm] | 1.09 | 2.01 | 3.66 |

(*1) Weight-average molecular weight of glucan prior to introduction of acyl groups
(*2) Ratio of the number of the glucoside bonds A to the total number of the glucoside bonds
(*3) Peeling (anchoring failure) between the pressure-sensitive adhesive sheet and the substrate sheet and cohesive failure of the pressure-sensitive adhesive sheet were observed while the peeling strength F was measured.

TABLE 3

| | | | Example 18 | | Example 19 | |
|---|---|---|---|---|---|---|
| Pressure- | Glucan | Kind | pullulan | laminaran | pullulan | laminaran |
| sensitive | | | derivative 3 | derivative 1 | derivative 3 | derivative 1 |

| | | | | | |
|---|---|---|---|---|---|
| adhesive | Blending amount | 10 | 90 | 10 | 90 |
| composition | (parts by weight) | | | | |
| | Weight-average | 500000 | 30000 to 40000 | 500000 | 30000 to 40000 |
| | molecular weight | | | | |
| | (*1) | | | | |
| | Constituent | α-glucose | β-glucose | α-glucose | β-glucose |
| | monomer | | | | |
| | Glucoside bond | α-1,6- | β-1,6- | α-1,6- | β-1,6- |
| | A | glucoside | glucoside | glucoside | glucoside |
| | Glucoside bond | α-1,4- | β-1,3- | α-1,4- | β-1,3- |
| | B | glucoside | glucoside | glucoside | glucoside |
| | Ratio P1 [%] (*2) | 33 | 25 | 33 | 25 |
| | The number of | 12 | 12 | 12 | 12 |
| | carbon atoms in | | | | |
| | acyl group | | | | |
| | Degree of | 2.4 | 3.0 | 2.4 | 3.0 |
| | substitution (DS | | | | |
| | value) | | | | |

| | | | |
|---|---|---|---|
| Tackifier | Kind | rosin-based resin | rosin-based resin |

| | KE100 | KE100 |
|---|---|---|
| Blending | 30 | 50 |
| amount | | |
| (parts by | | |
| weight) | | |

| | | | |
|---|---|---|---|
| Crosslinking | Kind | — | — |
| agent | Blending | — | — |

amount
(parts by
weight)

| | | | |
|---|---|---|---|
| Characteristics | Peeling strength F [N/20 mm] | 5.58 (cohesive failure) | 6.71 (cohesive failure) |

| | |
|---|---|
| Example 20 | Example 21 |

| Pressure- | Glucan | Kind | pullulan | laminaran | pullulan | laminaran |
|---|---|---|---|---|---|---|
| sensitive | | | derivative 3 | derivative 1 | derivative 3 | derivative 1 |

| | | | | | |
|---|---|---|---|---|---|
| adhesive | Blending amount | 50 | 50 | 50 | 50 |
| composition | (parts by weight) | | | | |
| | Weight-average | 500000 | 30000 to 40000 | 500000 | 30000 to 40000 |
| | molecular weight | | | | |
| | (*1) | | | | |
| | Constituent | α-glucose | β-glucose | α-glucose | β-glucose |
| | monomer | | | | |
| | Glucoside bond | α-1,6- | β-1,6- | α-1,6- | β-1,6- |
| | A | glucoside | glucoside | glucoside | glucoside |
| | Glucoside bond | α-1,4- | β-1,3- | α-1,4- | β-1,3- |
| | B | glucoside | glucoside | glucoside | glucoside |
| | Ratio P1 [%] (*2) | 33 | 25 | 33 | 25 |
| | The number of | 12 | 12 | 12 | 12 |
| | carbon atoms in | | | | |
| | acyl group | | | | |
| | Degree of | 2.4 | 3.0 | 2.4 | 3.0 |
| | substitution (DS | | | | |
| | value) | | | | |

| | | | |
|---|---|---|---|
| Tackifier | Kind | rosin-based resin | rosin-based resin |

| | KE100 | KE100 |
|---|---|---|
| Blending | 30 | 50 |

amount
(parts by
weight)

| | | | |
|---|---|---|---|
| Crosslinking | Kind | — | — |
| agent | Blending | — | — |

amount
(parts by
weight)

| | | | |
|---|---|---|---|
| Characteristics | Peeling strength F | 2.72 | 3.95 |

[N/20 mm]

(*1) Weight-average molecular weight of glucan prior to introduction of acyl groups
(*2) Ratio of the number of the glucoside bonds A to the total number of the glucoside bonds

TABLE 4

| | | | | | Comp. Ex. | Comp. Ex. |
|---|---|---|---|---|---|---|
| | | | Example 22 | | 1 | 2 |
| Pressure- | Glucan | Kind | pullulan | laminaran | pullulan | laminaran |
| sensitive | | | derivative 3 | derivative 1 | | |

| | | | | | |
|---|---|---|---|---|---|
| adhesive | Blending amount | 90 | 10 | — | — |
| composition | (parts by weight) | | | | |
| | Weight-average | 500000 | 30000 to 40000 | 500000 | 30000 to 40000 |
| | molecular weight | | | | |
| | (*1) | | | | |
| | Constituent | α-glucose | β-glucose | α-glucose | β-glucose |
| | monomer | | | | |
| | Glucoside bond | α-1,6- | β-1,6- | α-1,6- | β-1,6- |
| | A | glucoside | glucoside | glucoside | glucoside |
| | Glucoside bond | α-1,4- | β-1,3- | α-1,4- | β-1,3- |
| | B | glucoside | glucoside | glucoside | glucoside |
| | Ratio P1 [%] (*2) | 33 | 25 | 33 | 25 |
| | The number of | 12 | 12 | — | — |
| | carbon atoms in | | | | |
| | acyl group | | | | |
| | Degree of | 2.4 | 3.0 | 0 | 0 |
| | substitution (DS | | | | |
| | value) | | | | |

| | | | | |
|---|---|---|---|---|
| Tackifier | Kind | — | — | — |

| Blending | — | — | — |
|---|---|---|---|
| amount | | | |
| (parts by | | | |
| weight) | | | |

| | | | | |
|---|---|---|---|---|
| Crosslinking | Kind | — | — | — |
| agent | Blending | — | — | — |

amount
(parts by
weight)

| Characteristics | Peeling strength F | 1.54 | 0 | 0 |
|---|---|---|---|---|
| | [N/20 mm] | | | |

(*1) Weight-average molecular weight of glucan prior to introduction of acyl groups
(*2) Ratio of the number of the glucoside bonds A to the total number of the glucoside bonds

As is indicated in Tables 1 to 4, in the pressure-sensitive adhesive sheets of the examples, each of which was formed from the pressure-sensitive adhesive composition that included the glucan derivative G having the glucoside bonds A and B, the peeling strength F indicated a higher value as compared with the comparative examples. According to the examinations made by the inventors of the present invention, the peeling strength F of the pressure-sensitive adhesive sheets of the examples tends to be higher than the peeling strength F of a pressure-sensitive adhesive sheet formed from a pressure-sensitive adhesive composition including a glucan derivative (for example, paramylon derivative) having a single kind of a glucoside bond.

### INDUSTRIAL APPLICABILITY

The pressure-sensitive adhesive composition of the present embodiment can be used for a pressure sensitive adhesive tape.

1. A pressure-sensitive adhesive composition comprising a glucan derivative having a glucoside bond A, and a glucoside bond B having a different bonding form from the glucoside bond A.

2. The pressure-sensitive adhesive composition according to claim 1, wherein the glucoside bond A is a 1,6-glucoside bond.

3. The pressure-sensitive adhesive composition according to claim 1, wherein the glucoside bond B is at least one selected from the group consisting of a 1,3-glucoside bond and a 1,4-glucoside bond.

4. The pressure-sensitive adhesive composition according to claim 1, wherein a ratio of a number of the glucoside bonds A to a total number of glucoside bonds included in the glucan derivative is 10% to 50%.

5. The pressure-sensitive adhesive composition according to claim 1, wherein the glucan derivative includes an acyl group.

6. The pressure-sensitive adhesive composition according to claim 5, wherein a number of carbon atoms in the acyl group is 8 to 16.

7. The pressure-sensitive adhesive composition according to claim 5, wherein the acyl group is represented by formula (1) indicated below, 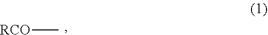
in the formula (1), R represents a hydrocarbon group.

8. The pressure-sensitive adhesive composition according to claim 5, wherein a degree of substitution (DS value) of the acyl group in the glucan derivative is more than 2.0.

9. The pressure-sensitive adhesive composition according to claim 1, wherein the glucan derivative includes at least one selected from the group consisting of a pullulan derivative and a laminaran derivative.

10. The pressure-sensitive adhesive composition according to claim 1, wherein the glucan derivative has a weight-average molecular weight of 5000000 or less.

11. The pressure-sensitive adhesive composition according to claim 1, further comprising a tackifier.

12. The pressure-sensitive adhesive composition according to claim 11, wherein the tackifier includes at least one selected from the group consisting of a terpene-based resin, a rosin-based resin, and a petroleum-based resin.

13. The pressure-sensitive adhesive composition according to claim 1, further comprising a crosslinking agent.

14. The pressure-sensitive adhesive composition according to claim 13, wherein the crosslinking agent includes an isocyanate-based crosslinking agent.

15. A pressure-sensitive adhesive sheet formed from the pressure-sensitive adhesive composition according to claim 1.

16. A laminate comprising:
the pressure-sensitive adhesive sheet according to claim 15; and
a substrate sheet.

17. A glucan derivative comprising:
a glucoside bond A;
a glucoside bond B having a different bonding form from the glucoside bond A; and
an acyl group having 8 to 16 carbon atoms.
